(19) United States
(12) Patent Application Publication
(10) Pub. No.: US 2025/0297872 A1
(43) Pub. Date: Sep. 25, 2025

(54) COMBINED PRESSURE AND TEMPERATURE SENSING DEVICE

(71) Applicant: HONEYWELL INTERNATIONAL INC., Charlotte, NC (US)

(72) Inventors: Vijaya Krishna N K, Charlotte, NC (US); Prateek U. DANTI, Charlotte, NC (US); Shivaraj GIRAMALLANAVAR, Charlotte, NC (US); Satamanyu DASH, Charlotte, NC (US)

(21) Appl. No.: 19/071,335

(22) Filed: Mar. 5, 2025

(30) Foreign Application Priority Data
Mar. 21, 2024 (IN) 202411021607

(51) Int. Cl. G01D 21/02; G01D 11/24; G01K 1/14; G01K 7/18; G01L 19/00

(52) U.S. Cl. CPC G01D 21/02; G01D 11/245; G01K 1/14; G01L 19/0092; G01K 7/18; G01L 2019/0053

(57) ABSTRACT

A combined pressure and temperature sensing device and method is disclosed. The combined pressure and temperature sensing device comprises a pressure detector configured to sense a pressure of a media, a temperature probe disposed within a capsule and electrically coupled with transistor outline (TO) header pins. Further, the temperature probe is configured to sense temperature of the media. Thereafter, the TO header pins are enclosed within a glass case attached to the capsule that is configured to isolate the TO header pins from the media.

### CROSS-REFERENCE TO RELATED APPLICATION

This application claims priority pursuant to 35 U.S.C. 119 (a) to Indian Application No. 202411021607, filed Mar. 21, 2024, which application is incorporated herein by reference in its entirety.

### TECHNOLOGICAL FIELD

Example embodiments of the present disclosure relate generally to a sensing device, and more particularly, to a combined pressure and temperature sensing device.

### BACKGROUND

In industrial applications using one or more media, the pressure and temperature of a media used are measured. Conventionally, two different sensors are used to monitor the pressure and the temperature. However, industrial applications may require a single sensing device to be used to measure pressure and temperature, which may be due to form factor or other requirements. Conventional combined pressure and temperature sensing devices are limited in their capabilities.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a combined pressure and temperature sensing device is disclosed. The combined pressure and temperature sensing device comprises a pressure detector configured to sense a pressure of a media; a temperature probe disposed within a capsule and electronically coupled with transistor outline (TO) header pins. Further, the temperature probe is configured to sense temperature of the media. Further, the TO header pins are enclosed within a glass case attached to the capsule that is configured to isolate the TO header pins from the media.

In some embodiments, the combined pressure and temperature sensing device further comprises an inlet port configured to direct the media within the combined pressure and temperature sensing device. Further, the inlet port having a plurality of threads on an housing of the combined pressure and temperature sensing device configured to mount the combined pressure and temperature sensing device over a media source.

In some embodiments, the glass case is filled with a first material. The first material corresponds to a thermally conductive and electrically insulated fluid that is configured to conduct heat energy of the media to the TO header pins.

In some embodiments, the pressure detector is coupled with the TO header pins and is housed within at least one hex ring. In some embodiments, the pressure detector is positioned within proximity to at least one diaphragm attached to the at least one hex ring. Further, the pressure detector and the at least one diaphragm form an enclosure. In some embodiments, the enclosure is filled with incompressible oil. Further, the incompressible oil is configured to transfer pressure exerted by the media over the at least one diaphragm to the pressure detector for sensing the pressure of the media.

In some embodiments, the combined pressure and temperature sensing device further comprises at least one printed circuit board assembly (PCBA) electrically coupled to the temperature probe and the pressure detector via each TO header pin. In some embodiments, the at least one PCBA is configured to receive data generated by the temperature probe and the pressure detector via each TO header pin.

In some embodiments, the at least one PCBA is configured to process the received data to determine one or more of a temperature or pressure of the media. In some embodiments, the pressure detector is configured to operate at a pressure range up to 500 bar and the temperature probe is configured to operate at a temperature range of −40 degrees to 150 degrees Celsius.

In an example embodiment, a method is disclosed. The method comprises steps of providing a pressure detector and a temperature probe. The temperature probe is coupled to transistor outline (TO) header pins that are enclosed within a glass case to isolate from a media. Further, exposing, via an inlet port, the pressure detector and the temperature probe to the media. Further, sensing, via the pressure detector, a pressure of the media. Further, sensing, via the temperature probe disposed within a capsule and coupled with the TO header pins, a temperature of the media. Further, generating, via the pressure detector and the temperature probe, data corresponding to a pressure and a temperature of the media.

The above summary is provided for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a perspective view of a combined pressure and temperature sensing device in accordance with an example embodiment of the present disclosure;

FIG. 2 illustrates a sectional view of the combined pressure and temperature sensing device in accordance with a first example embodiment of the present disclosure;

FIG. 3 illustrates a sectional view of the combined pressure and temperature sensing device in accordance with a second example embodiment of the present disclosure;

FIG. 4 illustrates a sectional view of the combined pressure and temperature sensing device in accordance with a third example embodiment of the present disclosure;

FIG. 5 illustrates a block diagram of the combined pressure and temperature sensing device in accordance with one or more embodiments of the present disclosure;

FIG. 6 illustrates a schematic view of at least one signal conditioning circuitry associated with the combined pressure and temperature sensing device in accordance with one or more embodiments of the present disclosure; and,

FIG. 7 illustrates a flowchart of a method in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of combined pressure and temperature sensing devices to measure a temperature and a pressure applied by at least one media. Embodiments may detect one or more analog readings of the pressure applied by the at least one media and/or of the temperature of the at least one media. Embodiments may convert the one or more analog readings into one or more digital output signals. Embodiments may connect the combined pressure and temperature sensing device with one or more computing equipment. Embodiments may allow integration of the combined pressure and temperature sensing device in various settings and configurations.

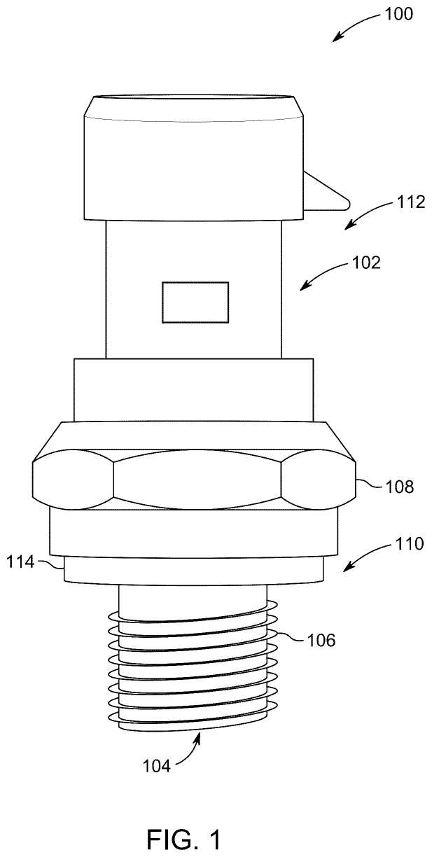

FIG. 1 illustrates a perspective view of a combined pressure and temperature sensing device 100, in accordance with an example embodiment of the present disclosure.

In some embodiments, the combined pressure and temperature sensing device 100 is configured to measure a temperature and a pressure applied by at least one media. The combined pressure and temperature sensing device 100 has a housing 102 that may comprise an inlet port 104, a plurality of threads 106, and at least one hex ring 108. In some embodiments, the combined pressure and temperature sensing device 100 may be configured to be fastened with a media source (not shown), such as with the plurality of threads 106 of the inlet port 104. In some embodiments, the housing 102 may be crafted in a manner that provides an enclosed space to accommodate one or more electrical/electronic and mechanical elements associated with the combined pressure and temperature sensing device 100. In some embodiments, the housing 102 may comprise a first portion 110, a second portion 112, and the at least one hex ring 108. In some embodiments, the at least one hex ring 108 may be welded between the first portion 110 and second portion 112.

In some embodiments, the inlet port 104 may be configured to receive the media to be monitored. In some embodiments, the media may be hydraulic fluid, water, steam, corrosive fluid, or any other such media. In some embodiments, the media may be supplied from the media source into the combined pressure and temperature sensing device 100. In some embodiments, the inlet port 104 may be crafted at the first portion 110 of the housing 102. Further, the inlet port 104 may be a first shape, such as a cylindrical shape, a square shape, a rectangular shape, etc. In some embodiments, the inlet port 104 may allow the media to enter from the first portion 110. In an exemplary embodiment, the combined pressure and temperature sensing device 100 may be configured to directly install or flush mount over the media source without the need of the inlet port 104 to channel the media within the combined pressure and temperature sensing device 100.

In some embodiments, the inlet port 104 may be configured to direct the media inside the combined pressure and temperature sensing device 100.

In some embodiments, the inlet port 104 may be machined with the plurality of threads 106. In some embodiments, the plurality of threads 106 may be configured to allow integration of the combined pressure and temperature sensing device 100 with the media source. In an exemplary embodiment, the plurality of threads 106 may correspond to one or more external threads 106. Further, the one or more external threads 106 may be configured to enable fastening of the combined pressure and temperature sensing device 100 with a plurality of internal threads (not shown) of the media source. In an exemplary embodiment, the plurality of threads 106 may correspond to one or more internal threads (not shown). Further, the one or more internal threads may be configured to enable fastening of the combined pressure and temperature sensing device 100 with a plurality of external threads (not shown) that may be machined on the media source.

In some embodiments, the first portion 110 of the housing 102 may comprise an O-ring 114. In some embodiments, the O-ring 114 may be compressed upon fastening of the housing 102 with the media source. In some embodiments, the O-ring 114 may seal an interface section between the plurality of threads 106 and the media source. In some embodiments, the first portion 110 and the at least one hex ring 108 may be constructed with a material comprising at least one of nickel-plated brass, stain less steel, or the like. Further, the material of the first portion 110, the at least one hex ring 108, and the second portion 112 may be selected in a view that ensures reliable operation of the combined pressure and temperature sensing device 100 in every ambient condition.

In some embodiments, the second portion 112 of the housing 102 may be configured to allow connection of the combined pressure and temperature sensing device 100 with one or more computing equipment (not shown). In an exemplary embodiment, the one or more computing equipment comprises at least one of Single Edge Nibble Transmission (SENT) and CAN (Controller Area Network) output with at least one Printed Circuit Board Assembly (PCBA). In some embodiments, the second portion 112 of the housing 102 may comprise at least two connector terminals (not shown). Further, the at least two connector terminals may be configured to convey one or more electrical signals generated by the combined pressure and temperature sensing device 100 to the one or more computing equipment.

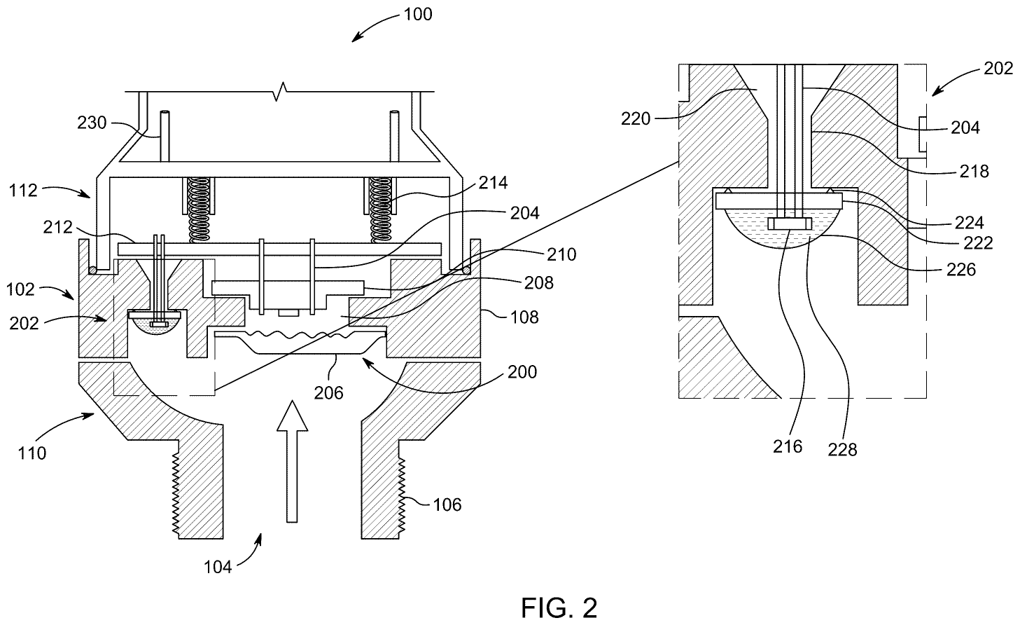

FIG. 2 illustrates a sectional view of the combined pressure and temperature sensing device 100, in accordance with one or more embodiments of the present disclosure. In some embodiments, the combined pressure and temperature sensing device 100 may comprise a pressure detector 200, a temperature detector 202, and transistor outline (TO) header pins 204.

In some embodiments, the pressure detector 200 may be configured to sense the pressure of the media. In some embodiments, the pressure detector 200 may be integrated with the at least one hex ring 108. In an exemplary embodiment, the pressure detector 200 may correspond to a Microelectromechanical system (MEMS) sensor. Further, the MEMS sensor may comprise electrical and mechanical components that are configured to detect pressure applied by the media. In some embodiments, the pressure detector 200 may be positioned in proximity to at least one diaphragm 206. Such placement of the pressure detector 200 with respect to the at least one diaphragm 206 may be such that an enclosure 208 is created between the pressure detector 200 and the at least one diaphragm 206. In some embodiments, the at least one diaphragm 206 may be attached with the at least one hex ring 108.

In some embodiments, the at least one diaphragm 206 may be configured to harness one or more analogue signals corresponding to the pressure applied by the media, in contact with the at least one diaphragm 206. In some embodiments, the at least one diaphragm 206 may be crafted with a flexible material. Further, the flexible material of the at least one diaphragm 206 allows the at least one diaphragm 206 to compress or expand during application of the pressure from the media. In some embodiments, the pressure applied by the media may result in compression of the at least one diaphragm 206.

In some embodiments, the pressure detector 200 and the at least one diaphragm 206 may form the enclosure 208. Further, the enclosure 208 may be filled with an incompressible oil (not shown). The incompressible oil may be configured to translate the pressure applied by the media over the at least one diaphragm 206 to the pressure detector 200 for sensing the pressure of the media. The pressure detector 200 may further comprise at least one sensing die 210. In an exemplary embodiment, the incompressible oil may also maintain isolation of the at least one diaphragm 206 from the at least one sensing die 210.

In some embodiments, the at least one sensing die 210 may be configured to generate one or more electrical signals upon application of pressure by the incompressible oil. In some embodiments, the at least one sensing die 210 may further comprise one or more piezo-resistor implanted inside a silicon membrane (not shown). Further, the at least one sensing die 210 may be configured to experience a mechanical strain due to pressure translated by the at least diaphragm 206 via the incompressible oil. In some embodiments, the mechanical strain may be transformed into one or more electrical signals. Further, the one or more electrical signals may possess fluctuating characteristics due to inconsistent pressure applied by the media over the at least one diaphragm 206.

In some embodiments, the second portion 112 of the housing 102 may comprise the TO header pins 204. In some embodiments, the TO header pins 204 may be electrically coupled with the pressure detector 200. In some embodiments, the TO header pins 204 may be affixed with a glass seal (not shown). Further, the glass seal may be configured to isolate the TO header pins 204 from the media. In an exemplary embodiment, the isolation of the TO header pins 204 may enhance in durability and working range of the combined pressure and temperature sensing device 100.

In some embodiments, the TO header pins 204 may be electrically coupled with the pressure detector 200. Further the TO header pins 204 may be configured to receive the one or more electrical signals from the at least one sensing die 210. In some embodiments, upon receiving the one or more electrical signals, the TO header pins 204 may be configured to convey the one or more electrical signals to at least one Printed Circuit Board Assembly (PCBA) 212 electrically coupled with the TO header pins 204. Further, the one or more electrical signals may be received by at least one signal conditioning circuitry (not shown) fabricated over the at least one PCBA 212.

In some embodiments, the at least one signal conditioning circuitry may be configured to eliminate the fluctuations present in the one or more electrical signals. In some embodiments, upon successful conditioning of the one or more electrical signals, the at least one PCBA 212 provides one or more output signals to at least one pair of connectors 214 electrically coupled with the at least one PCBA 212.

In some embodiments, the temperature detector 202 may comprise a temperature probe 216, a capsule and the TO header pins 204. In some embodiments, the temperature probe 216 may be disposed within a capsule 218. In some embodiments, the temperature probe 216 may be configured to sense a temperature of the media. In some embodiments, the capsule 218 may be crafted with one or more thin sheets. The one or more thin sheets may be crafted with a material comprising aluminum, copper, or the like. In some embodiments, the capsule 218 may be configured to accommodate the temperature probe 216. Further, the capsule 218 may be configured to isolate the temperature probe 216 from the media.

Further, the media may be in direct contact with the capsule 218. In some embodiments, the temperature probe 216 may correspond to a Surface Mount Device (SMD) probe. In some embodiments, the temperature probe 216 may be operationally coupled with the at least one hex ring 108. In some embodiments, the at least one hex ring 108 may be machined with at least one hole 220 that may be configured to accommodate the temperature probe 216. In an exemplary embodiment, the temperature probe 216 may be welded with the at least one hole 220 that secures the temperature probe 216 inside the at least one hole 220.

In some embodiments, the temperature probe 216 may be secured inside the at least hole 220 by using at least one fixture 222. Further, the at least one fixture 222 may be affixed with the at least one hex ring 108 through a pair of welded joints 224. In some embodiments, the pair of welded joints 224 may be configured to ensure durability of the temperature probe 216 while working at a higher operating range.

In some embodiments, the TO header pins 204 may be electrically coupled with the temperature probe 216. In some embodiments, the TO header pins 204 may be enclosed within a glass case 226. Further, the glass case 226 may be configured to isolate the TO header pins 204 from the media. In some embodiments, the glass case 226 may be filled with a first material 228. Further, the first material 228 may be an adhesive that is thermally conductive and electrically insulated adhesive fluid that may be configured to conduct heat energy of the media to the temperature probe 216.

In some embodiments, the first material 228 may be configured to conduct the heat energy of the media in direct contact with the glass case 226 to the temperature probe 216 to determine temperature of the media. Further, the first material 228 may prevent any conduction of the electric current within the media by insulating the TO header pins 204 from the media. In an exemplary embodiment, the isolation of the TO header may enhance in durability and working range of the combined pressure and temperature sensing device 100.

In some embodiments, the temperature probe 216 may be configured to sense temperature of the media in direct contact with the capsule 218. In some embodiments, electrical resistance of the temperature probe 216 may be inversely proportional to the temperature of the media. In an exemplary embodiment, the electrical resistance of the temperature probe 216 may be directly proportional to the temperature of the media. In an exemplary embodiment, any change in the temperature of the media may result in varying the output voltage of the temperature probe 216. In some embodiments, the temperature probe 216 may be configured to generate one or more output signals corresponding to temperature of the media. Further, the one or more output signals may correspond to one or more electrical signals.

In some embodiments, the temperature probe pins may be mechanically soldered with the at least one PCBA 212 via the TO header pins 204. Further, the one or more output signals of the temperature probe 216 may be supplied to the at least one signal conditioning circuitry via the TO header pins 204. In some embodiments, the at least one signal conditioning circuitry may be configured to eliminate any fluctuation present in the one or more output signals. In some embodiments, after altering the fluctuations, the at least one signal conditioning circuitry may be configured to provide one or more output signals. Further, the one or more output signals may be fetched by the one or more computing equipment by using at least two connector terminals 230.

In some embodiments, the at least one pair of connectors 214 may be operationally coupled with the at least two connector terminals 230. Further, the at least one pair of connectors 214 may correspond to at least two coils that may be configured to transfer the received one or more output signals to the at least two connector terminals 230. In some embodiments, the at least two connector terminals 230 may be configured to allow integration of the combined pressure and temperature sensing device 100 with the one or more computing equipment. Further, the at least two connector terminals 230 may be configured to feed the one or more output signals to the one or more computing equipment. In some embodiments, the one or more output signals may correspond to the one or more electrical signals having linear characteristics.

In one embodiment, after eliminating the fluctuations, the at least one signal conditioning circuitry fabricated on the at least one PCBA 212 may be configured to generate the one or more output signals. Further, the one or more output signals may correspond to data that provides the pressure and temperature of the media. Further, the data may be fetched by the one or more computing equipment using the at least two connector terminals 230.

In another embodiment, the at least one signal processing circuitry may be configured to provide the one or more output signals after eliminating the fluctuations. Further, the one or more output signals may correspond to the one or more electrical signals that may be fetched by the one or more computing equipment through the at least two connector terminals 230. Further, the one or more computing equipment may be configured to process the received one or more output signals to generate data that provides pressure and temperature of the media.

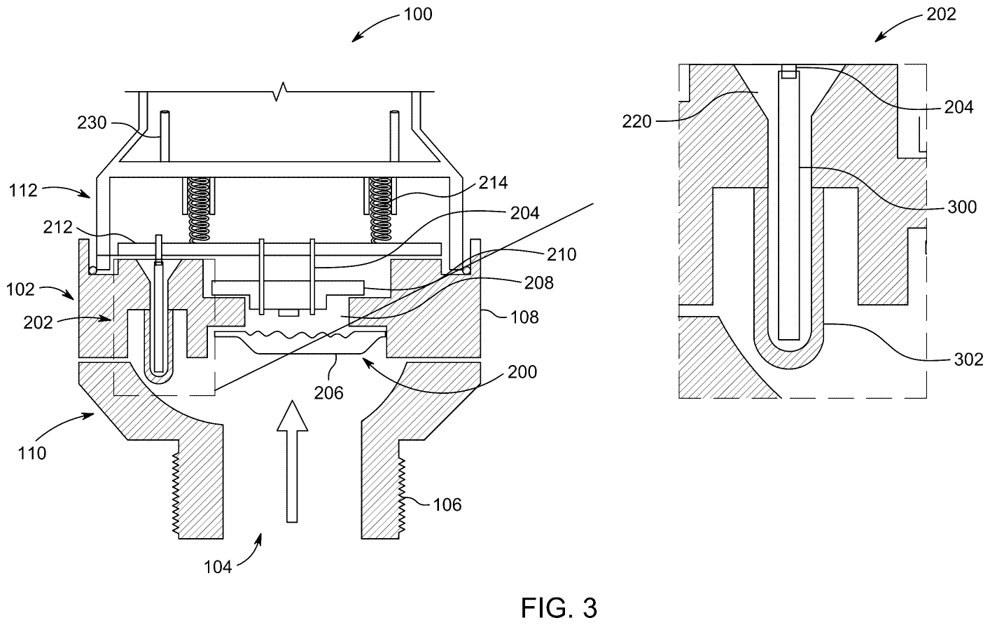

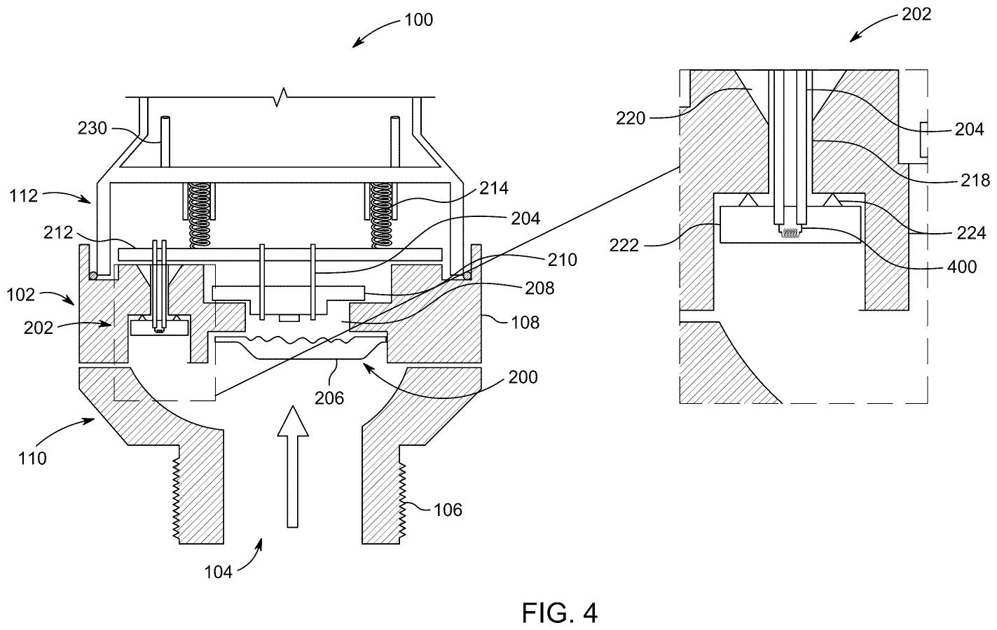

FIG. 3 illustrates a sectional view of the combined pressure and temperature sensing device 100, in accordance with an example embodiment of the present disclosure. FIG. 4 illustrates a sectional view of the combined pressure and temperature sensing device 100, in accordance with another example embodiment of the present disclosure.

In some embodiments, the temperature detector 202 may comprise, a temperature probe 300 and a capsule 302. The temperature probe 300 may be disposed within the capsule 302. In an exemplary embodiment, the temperature probe 300 may correspond to a Platinum-Resistance Temperature Detector (PT-RTD) probe. Further, the temperature probe 300 may be configured to sense the temperature of the media in contact with the capsule 302. In some embodiments, the direct contact of the capsule 302 may enhance an area of contact of the temperature probe 300. Further, the enhanced area of contact may prevent temperature data loss.

In some embodiments, the temperature probe pins may be soldered with the at least one PCBA 212. In some embodiments, the capsule 302 may be welded with the at least one hole 220 machined on the at least one hex ring 108. In some embodiments, the temperature probe 300 may be configured to provide one or more output signals corresponding to temperature of the media. Further, the temperature probe 300 may be configured to transfer the one or more output signals to the at least one signal conditioning circuitry. Further, the at least one signal conditioning circuitry may be configured to alter any fluctuations present in the one or more output signals to provide one or more output signals. Further, the one or more output signals may be fetched by the one or more computing equipment by using the at least two connector terminals 230.

As illustrated in FIG. 4, the temperature detector 202 may comprise a temperature probe 400, a capsule 218 and the TO header pins 204. The temperature probe 400 may be encapsulated inside the capsule 218. In some embodiments, the capsule 218 may be in direct contact with the media. In an exemplary embodiment, the temperature probe 400 may correspond to a Surface Mount Device (SMD) probe. In an exemplary embodiment, the temperature probe 400 may be welded with one or more holes (not shown) machined on the capsule 218. In some embodiments, the one or more holes may enhance an area of contact of the temperature probe 400 with the media. In some embodiments, the temperature probe 400 may be configured to sense the temperature of the media and provide corresponding one or more output signals. In some embodiments, the capsule 218 may be inserted inside the at least one hole 220 machined over the at least one hex ring 108.

In some embodiments, the temperature probe 400 may be secured inside the at least hole 220 by using the at least one fixture 222. Further, the at least one fixture 222 may be affixed with the at least one hex ring 108 through a pair of welded joints 224. In some embodiments, the pair of welded joints 224 may be configured to ensure durability of the temperature probe 400 while working at a higher operating range

In some embodiments, the TO header pins 204 may be electrically coupled with the temperature probe 400. In some embodiments, the TO header pins 204 may be configured to transfer the one or more output signals to the at least one PCBA 212. In some embodiments, the TO header pins 204 may be soldered with the at least one PCBA 212. In some embodiments, the at least one signal conditioning circuitry may be configured to receive the one or more output signals. Further, the at least one signal conditioning circuitry may alter any fluctuations present in the one or more output signals to provide one or more output signals. Further, the one or more output signals may be fetched by the one or more computing equipment by using the at least two connector terminals 230.

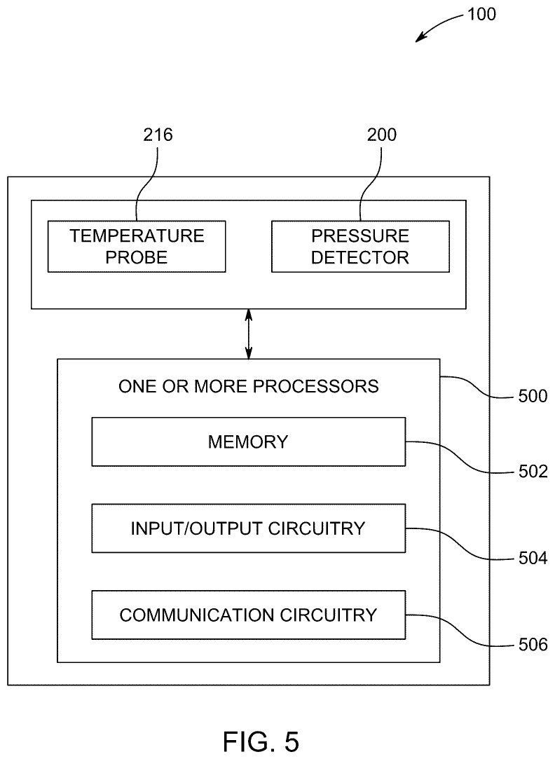

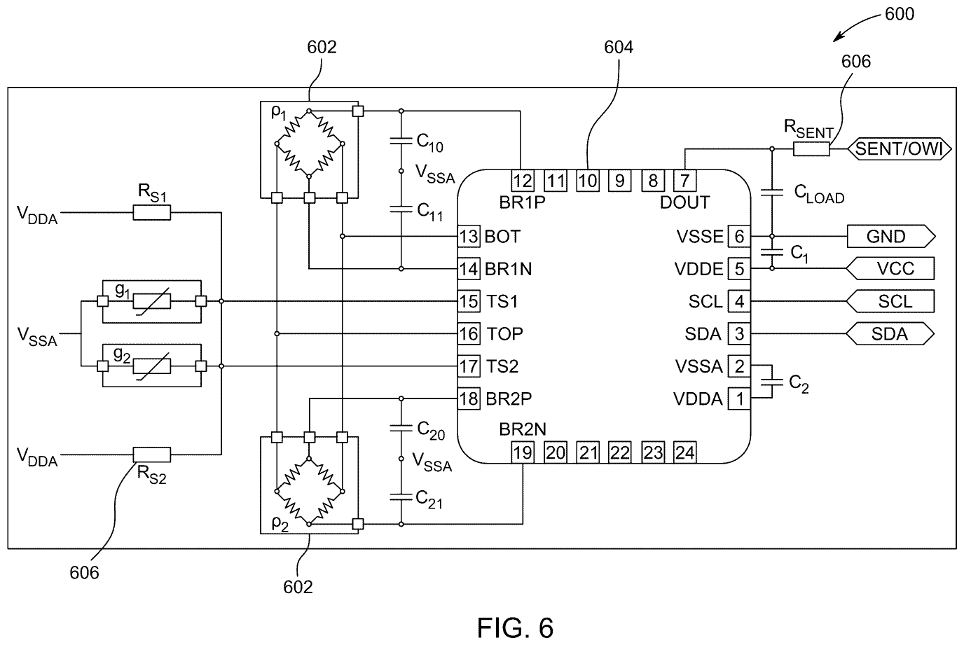

FIG. 5 illustrates a block diagram of the combined pressure and temperature sensing device 100, in accordance with one or more embodiments of the present disclosure. FIG. 6 illustrates a schematic diagram of an at least one signal conditioning circuitry 600 associated with the combined pressure and temperature sensing device 100, in accordance with one or more embodiments of the present disclosure.

In some embodiments, the combined pressure and temperature sensing device 100 may comprise the pressure detector 200, the temperature probe 216, and one or more processors 500. In some embodiments, the pressure detector 200 may be configured to sense pressure applied by the media over the at least one diaphragm 206. In some embodiments, the pressure detector 200 may comprise at least one sensing die 210. In some embodiments, the at least one sensing die 210 may be configured to generate data (one or more output signals) corresponding to pressure applied by the media. In some embodiments, the temperature probe 216 may be housed inside the capsule 218. Further, the capsule 218 may be in direct contact with the media received from the media source. In some embodiments the temperature probe 216 may be configured to sense temperature of the media. In some embodiments, the temperature probe 216 may be configured to generate data (the one or more output signals) corresponding to temperature of the media.

In some embodiments, the temperature probe 216 and the pressure detector 200 may be soldered with the at least one PCBA 212 via the TO header pins 204. In some embodiments, the TO header pins 204 may be configured to supply the data corresponding to the temperature of the media and pressure applied by the media, to the at least one PCBA 212. In some embodiments, the at least one PCBA 212 may be fabricated with the at least one signal conditioning circuitry 600. In some embodiments, the at least one signal conditioning circuitry 600 may be configured to receive the data. Further, the at least one signal conditioning circuitry 600 may be configured to process the received data to provide the one or more output signals.

As illustrated in FIG. 6, the at least one signal conditioning circuitry 600 may be configured to eliminate the fluctuations present in the received one or more output signals. In an exemplary embodiment, the at least one signal conditioning circuitry 600 may comprise one or more resistive bridges 602, at least one integrated circuit 604 and one or more active/passive electronic components 606 required for conditioning the received data. In some embodiments, upon successful conditioning of the data, the at least one signal conditioning circuitry 600 may provide the one or more output signals. Further, the one or more output signals may be fetched by the one or more computing equipment by using the at least two connector terminals 230.

In some embodiments, the one or more processors 500 may be operationally coupled with the at least two connector terminals 230. In some embodiments, the one or more processors 500 may include suitable logic, circuitry, and/or interfaces that are operable to execute one or more instructions stored in a memory 502 to perform predetermined operations. In some embodiments, the one or more processors 500 may be configured to decode and execute any instructions received from one or more other electronic devices or server(s). The one or more processors 500 may be configured to execute one or more computer-readable program instructions, such as program instructions to carry out any of the functions described in this description. Further, the one or more processors 500 may be implemented using one or more processor technologies. Examples of the one or more processors 500 include, but are not limited to, one or more general purpose processors (e.g., INTEL® or Advanced Micro Devices® (AMD) microprocessors) and/or one or more special purpose processors 500 (e.g., digital signal processors or Xilinx® System On Chip (SOC) Field Programmable Gate Array (FPGA) processor).

In some embodiments, the one or more processors 500 may be configured to receive the one or more output signals. Further, the one or more processors 500 may be configured to process the one or more received signals by implementing artificial intelligence/machine learning (AI/ML) protocols. For example, the one or more processors 500 may be integrated within the one or more computing equipment. Further, the one or more processors 500 may be configured to compare the processed data with a predefined threshold value. In some example embodiment, based at least on the comparison, the one or more processors 500 may operate an electronically controlled valve (ECV) to control flow of the media inside the media source.

In some embodiments, the memory 502 may store a set of instructions and data. In some embodiments, the memory 502 may include the one or more instructions that are executable by the one or more processors 500 to perform specific operations. It is apparent to a person with ordinary skill in the art that the one or more instructions stored in the memory 502 enable the hardware of the combined pressure and temperature sensing device 100 to perform the predetermined operations. Some of the commonly known memory 502 implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

Further, the one or more processors 500 may comprise an input/output circuitry that enables the user to communicate or interface with the combined pressure and temperature sensing device 100 via a user device (not shown). The user device may include N number of user devices. It may be noted that an input/output circuitry 504 may act as a medium to transmit input from the user device to and from the combined pressure and temperature sensing device 100. In some embodiments, the input/output circuitry 504 may refer to the hardware and software components that facilitate the exchange of information between the user and the combined pressure and temperature sensing device 100. In one example, the user device may include a graphical user interface (GUI) (not shown) as input circuitry to allow the user to input data. The input/output circuitry 504 may include various input devices such as keyboards, barcode scanners, GUI for the user to provide data and various output devices such as displays, printers for the user to receive data.

In some embodiments, the one or more processors 500 may comprise a communication circuitry 506. The communication circuitry 506 may allow the combined pressure and temperature sensing device 100 and the user device to exchange data or information with other systems or apparatuses. Further, the combined pressure and temperature sensing device 100 may be communicatively coupled with network interface and software modules for sending and receiving data or information. In some embodiments, the communication circuitry 506 may include Ethernet ports, Wi-Fi adapters, or communication protocols like HTTP or MQTT for connecting with other systems. In some embodiments, the user device may comprise at least one of mobile phone, laptop, or the like.

It will be apparent to one skilled in the art that above-mentioned components of the combined pressure and temperature sensing device 100 have been provided only for illustration purposes, without departing from the scope of the disclosure.

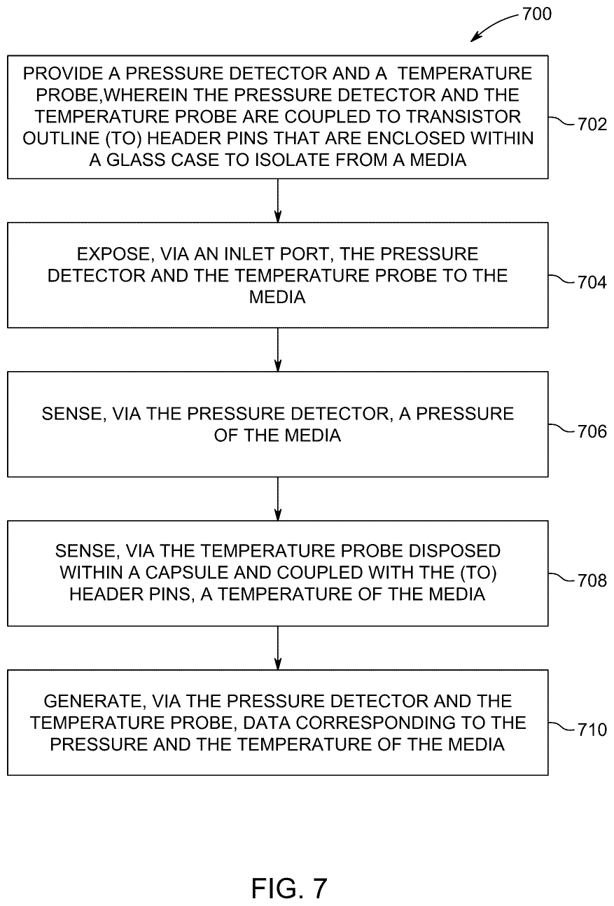

FIG. 7 illustrates a flowchart of a method 700, in accordance with an example embodiment of the present disclosure.

At operation 702, the pressure detector 200 and the temperature probe 216 may be provided. In some embodiments, the temperature probe 216 may be coupled to transistor outline (TO) header pins 204 that may be enclosed within a glass case 226 to isolate from the media. In some embodiments, the combined pressure and temperature sensing device 100 may be integrated within the housing 102. Further, the housing 102 may be integrated with a media source. In some embodiments, the housing 102 may comprise the TO header pins 204 enclosed within the glass case 226 to provide a higher operating range by isolating from the media. For example, the combined pressure and temperature sensing device 100 is integrated within a housing 102. Further, the housing 102 is attached to a pipeline. The pipeline may be configured to supply water from a source to an end.

At an operation 704, the pressure detector 200 and the temperature probe 216 may be exposed to the media by the inlet port 104. In some embodiments, the inlet port 104 may be crafted on the housing 102 that enables passage of the media inside the housing 102 from the media source. Further, the combined pressure and temperature sensing device 100 comprises the pressure detector 200 and the temperature probe 216. For example, the housing 102 is crafted with an inlet port 104 that enables passage of water inside the housing 102. Further, the combined pressure and temperature sensing device 100 comprises a pressure detector 200 and a temperature probe 216. Upon passage of the media through the inlet port 104, the pressure detector 200 and the temperature probe 216 get exposed to the media.

At an operation 706, the pressure detector 200 may sense the pressure of the media. Further, the pressure detector 200 may be positioned in proximity to at least one diaphragm 206. In some embodiments, the pressure detector 200 may comprise the at least one sensing die 210 that may be configured to generate one or more electrical signals upon application of pressure from the media. For example, the pressure detector 200 is configured to sense pressure of water flowing through the pipeline and in contact with the at least one diaphragm 206.

At an operation 708, the temperature probe 216 disposed within at least one capsule and coupled with transistor outline (TO) header pins 218, may sense temperature of the media. In some embodiments, the temperature probe 216 may be disposed within the capsule 218. Further, the temperature probe 216 may be coupled with the transistor outline (TO) header pins 204. In some embodiments, the capsule 218 may be directly exposed to the media. Further, the temperature probe 216 may be configured to sense temperature of the one media. For example, the temperature probe 216 may be configured to sense the temperature of water in the pipeline that comes in contact with the capsule 218.

At an operation 710, the pressure detector 200 and the temperature probe 216 may be configured to generate the data corresponding to the pressure and temperature of the media. In some embodiments, the pressure detector 200 may be configured to generate the data that may comprise the one or more output signals. In some embodiments, the temperature probe 216 may be configured to generate the data that may comprise the one or more output signals. Further, the pressure detector 200 and the temperature probe 216 may be soldered with the at least one PCBA 212 via the TO header pins 204. For example, the pressure detector 200 and temperature probe 216 are soldered with the at least one PCBA 212. Further, the data corresponding to the pressure of the water and a temperature of the water are supplied to the at least one PCBA 212 via the TO header pins 204.

Embodiments may allow the combined pressure and temperature sensing device 100 to operate at a pressure range of 1 bar to 150 bar. Embodiments may provide an overpressure that corresponds to 300 bar and a burst pressure approximately 500 bar to the combined pressure and temperature sensing device 100. Embodiments may provide a response time corresponding to more than 5 ms (milliseconds) for pressure detection and 500 ms for temperature detection. Embodiments may provide an operating temperature range of −40° C. to 150° C. to the sending device. Embodiments may allow the combined pressure and temperature sensing device 100 to stay thermally in contact with the at least one media and electrically isolated from the at least one media. Embodiments may allow integrations of the combined pressure and temperature sensing device 100 to different industrial applications and settings.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A combined pressure and temperature sensing device comprising:
a pressure detector configured to sense a pressure of a media; and,
a temperature probe disposed within a capsule and electrically coupled with transistor outline (TO) header pins, wherein the temperature probe is configured to sense temperature of the media, wherein the TO header pins are enclosed within a glass case attached to the capsule that is configured to isolate the TO header pins from the media.

2. The combined pressure and temperature sensing device of claim 1 further comprising an inlet port configured to direct the media within the combined pressure and temperature sensing device.

3. The combined pressure and temperature sensing device of claim 2, wherein the inlet port having a plurality of threads on a housing of the combined pressure and temperature sensing device configured to mount the sensing device over a media source.

4. The combined pressure and temperature sensing device of claim 1, wherein the glass case is filled with a first material, wherein the first material corresponds to a thermally conductive and electrically insulated fluid that is configured to conduct heat energy of the media to the TO header pins.

5. The combined pressure and temperature sensing device of claim 1, wherein the pressure detector is coupled with the TO header pins and integrated within at least one hex ring.

6. The combined pressure and temperature sensing device of claim 5, wherein the pressure detector is positioned within proximity to at least one diaphragm attached to the at least one hex ring, wherein the pressure detector and the at least one diaphragm form an enclosure.

7. The combined pressure and temperature sensing device of claim 6, wherein the enclosure is filled with incompressible oil, wherein the incompressible oil is configured to transfer pressure exerted by the media over the at least one diaphragm to the pressure detector for sensing the pressure of the media.

8. The combined pressure and temperature sensing device of claim 1 further comprising at least one printed circuit board assembly (PCBA) electrically coupled to the temperature probe and the pressure detector via each TO header pin, wherein the at least one PCBA is configured to receive data generated by the temperature probe and the pressure detector via each TO header pin.

9. The combined pressure and temperature sensing device of claim 8, wherein the at least one PCBA is configured to process the received data to determine one or more of a temperature or pressure of the media.

10. The combined pressure and temperature sensing device of claim 1, wherein the pressure detector is configured to operate at a pressure range of up to 500 bar and the temperature probe is configured to operate at a temperature range of −40 degrees to 150 degrees Celsius.

11. A method comprising:
providing a pressure detector and a temperature probe, wherein the temperature probe is coupled to transistor outline (TO) header pins that are enclosed within a glass case to isolate from a media;
exposing, via an inlet port, the pressure detector and the temperature probe to the media;
sensing, via the pressure detector, a pressure of the media;
sensing, via the temperature probe disposed within a capsule and coupled with the TO header pins, a temperature of the media; and,
generating, via the pressure detector and the temperature probe, data corresponding to a pressure and a temperature of the media.

12. The method of claim 11, wherein the inlet port is configured to direct the media within the combined pressure and temperature sensing device.

13. The method of claim 12, wherein the inlet port having a plurality of threads on a housing of the combined pressure and temperature sensing device is configured to mount the sensing device over a media source.

14. The method of claim 11, wherein the glass case is filled with a first material, wherein the first material corresponds to a thermally conductive and electrically insulated fluid that is configured to conduct heat energy of the media to the at least one TO header.

15. The method of claim 11, wherein the pressure detector is coupled with the TO header pins and integrated within at least one hex ring.

16. The method of claim 15, wherein the pressure detector is positioned within proximity to at least one diaphragm attached to the at least one hex ring, wherein the pressure detector and the at least one diaphragm form an enclosure.

17. The method of claim 16, wherein the enclosure is filled with incompressible oil, wherein the incompressible oil is configured to transfer pressure exerted by the media over the at least one diaphragm to the pressure detector for sensing the pressure of the media.

18. The method of claim 11 further comprising at least one printed circuit board assembly (PCBA) electrically coupled to the temperature probe and the pressure detector via each TO header pin, wherein the at least one PCBA is configured to receive data generated by the temperature probe and the pressure detector via each TO header pin.

19. The method of claim 18, wherein the at least one PCBA is configured to process the received data to determine one or more of a temperature or pressure of the media.

20. The method of claim 14, wherein the pressure detector is configured to operate at a pressure range of up to 500 bar and the temperature probe is configured to operate at a temperature range from −40 degrees to 150 degrees Celsius.
